(19) United States
(12) Patent Application Publication
(10) Pub. No.: US 2022/0242288 A1
(43) Pub. Date: Aug. 4, 2022

(54) CAR SEAT COVER

(71) Applicant: Bochia Design Ltd. Co., Taipei City (TW)

(72) Inventor: Wu Po-Jung, Taipei City (TW)

(21) Appl. No.: 17/585,631

(22) Filed: Jan. 27, 2022

(30) Foreign Application Priority Data
Jan. 29, 2021 (TW) 110103602

(51) Int. Cl. B60N 2/60

(52) U.S. Cl. CPC B60N 2/60

(57) ABSTRACT

A seat cover for an automobile comprises: a main body, a pocket and a first fixing element. The main body comprises a first pad and a second pad, wherein the first pad is connected with the second pad. The pocket comprises a first sheet, a second sheet and a fixing structure. The first sheet is connected with the first pad. The second sheet is substantially corresponded to the first sheet and the second sheet is connected with the first sheet to form an accommodation space which has an opening. The fixing structure is disposed on the second sheet and substantially near the opening. Both ends of the first fixing element are respectively connected to both sides of the second sheet. The main body of the seat cover for an automobile according to the present invention can be placed in the pocket so it is convenient for storage and increases the usability.

### BACKGROUND OF THE INVENTION

### 1. Field of the Invention

The present invention relates to a seat cover for an automobile, and, more particularly, to a seat cover for an automobile which enables to be folded into a pillow for support.

### 2. Description of the Related Art

At present, an automobile is one of the most commonly used means of transportation. In one aspect, when riding in the automobile, drivers or passengers may maintain the same posture for a long time, which would cause stiffness easily, especially for their cervical spine and lumbar spine. Therefore, a pillow that can support the neck or lumbar has become an essential product to enhance the comfortability in the automobile. In another aspect, temperatures have generally risen because of global warming. In addition, there is a trend of increased participation in sports. No matter driving the automobile for commuting, traveling or doing outdoor activities, there is a high chance that the automobile seats would get dirty from occupants', including drivers' or even pets', sweat, smudges, foods or drinks, and even be damaged by the sharp or rough edges of apparel or stuff carried by the occupants. It not only makes the driver or passengers feel uncomfortable but also causes the automobile to be polluted by long-term accumulated pathogens and even brings negative effects on health. Therefore, a good design of a seat cover for an automobile could avoid the above situation and provide more comfortable driving experience and environment inside the automobile for the driver and passengers.

The seat covers for automobiles of the prior art are used to protect the automobile seats or to increase the aesthetics of the automotive interior. However, the seat cover for automobile is commonly composed of stiff or thick material that could cause muggy and uncomfortable riding experience. After the seat cover for automobile is used, it is not easy for storage and does not have any other function.

Therefore, how to overcome the foregoing problems of the seat covers for automobiles of the prior art has become an urgent problem to be solved in the industry.

### SUMMARY OF THE INVENTION

In order to solve the aforementioned problems in the prior art, the present invention provides a seat cover for an automobile in which an automobile seat has a seat cushion, a backrest and a headrest, wherein the seat cover for an automobile comprises: a main body comprising a first pad and a second pad, wherein the first pad has a first edge and a second edge corresponding to the first edge of the first pad, and the second pad has a first edge and a second edge corresponding to the first edge of the second pad, wherein the second edge of the first pad is connected with the first edge of the second pad; a pocket comprising: a first sheet connected with the first edge of the first pad; a second sheet substantially connected with the first sheet to form an accommodation space which has an opening; and a fixing structure disposed on the second sheet and substantially near the opening; and a first fixing element disposed on the pocket and used for connecting and fastening the pocket to the automobile seat.

In an embodiment, the accommodation space is used to accommodate the headrest of the automobile seat.

In an embodiment of the present invention, the accommodation space is used to accommodate the main body.

In an embodiment of the present invention, the main body has a shape of cuboid or cylinder.

In an embodiment of the present invention, both ends of the first fixing element are respectively connected to both sides of the second sheet of the pocket, and a space between the first fixing element and the pocket is used to accommodate the headrest or support rods connecting the backrest and the headrest of the automobile seat.

In an embodiment of the present invention, the pocket is placed on the seat cushion and near the backrest of the automobile seat.

In an embodiment of the present invention, the pocket further comprises a pull strap disposed on a side of the pocket away from the first pad.

In an embodiment of the present invention, the main body further comprises at least one second fixing element, wherein both ends of the at least one second fixing element are respectively connected to both sides of the main body.

In an embodiment of the present invention, the first pad further has a third edge and a fourth edge, wherein the third edge is between the first edge and the second edge of the first pad and the fourth edge corresponds to the third edge of the first pad, and the first pad further comprises at least one third sheet, wherein the at least one third sheet is disposed along the third edge or the fourth edge of the first pad.

In an embodiment of the present invention, the first edge of the second pad is connected to the second edge of the first pad and a edge of the at least one third sheet.

In an embodiment of the present invention, the second pad further has a third edge and a fourth edge, wherein the third edge is between the first edge and the second edge of the second pad and the fourth edge corresponds to the third edge of the second pad, and the second pad further comprises at least one fourth sheet, wherein the at least one fourth sheet is disposed along the third edge or the fourth edge of the second pad.

In an embodiment of the present invention, a maximum length of the accommodation space is not less than a length of the first edge of the first pad.

In an embodiment of the present invention, part or all of the first sheet, the second sheet or the first fixing element is made of elastic materials.

In an embodiment of the present invention, the first fixing element is substantially parallel to the first edge of the first pad.

In an embodiment of the present invention, the second pad further comprises an anti-slip structure disposed on a surface of the second pad, which contacts the automobile seat.

In an embodiment of the present invention, the main body and the pocket are integrally formed.

In an embodiment of the present invention, the main body and the pocket are formed by draping technique.

In an embodiment of the present invention, the main body or the pocket comprises a first layer structure and a second layer structure, wherein the first layer structure is made of water absorbing, antimicrobial, deodorizing or mildewproof materials and the second layer structure is made of waterproof materials.

In an embodiment of the present invention, the main body or the pocket further comprise a third layer structure, wherein a thickness of the third layer structure is more than a thickness of the first layer structure or a thickness of the second layer structure.

Compared to the prior art, after the cover seat for an automobile of the present invention is used, the main body could be placed in the accommodation space of the pocket. The present invention is easy for storage and carrying. In addition, it can be used as a pillow for support to increase the practicability of the seat cover for an automobile.

### BRIEF DESCRIPTION OF THE DRAWINGS

FIG. 1 illustrates a back view of a seat cover for an automobile according to the present invention.

FIG. 2 illustrates a schematic view of a first state of use of a seat cover for an automobile according to the present invention.

FIG. 3 illustrates a schematic view of a second state of use of a seat cover for an automobile according to the present invention.

FIG. 4 illustrates a schematic view of a third state of use of a seat cover for an automobile according to the present invention.

FIG. 5 illustrates a schematic view of layer structures of a main body or a pocket according to the present invention.

### DETAILED DESCRIPTION

The present invention is described by the following specific embodiments. Those with ordinary skills in the arts can readily understand other advantages and functions of the present invention after reading the disclosure of this specification. Any changes or adjustments made to their relative relationships, without modifying the substantial technical contents, are also to be construed as within the range implementable by the present invention.

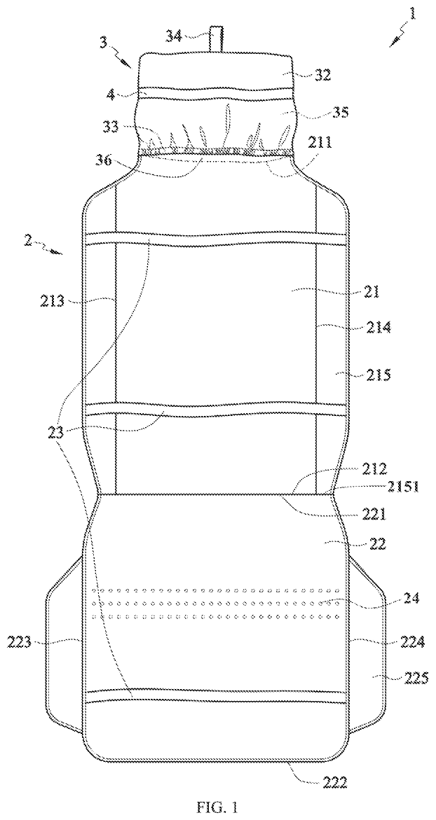

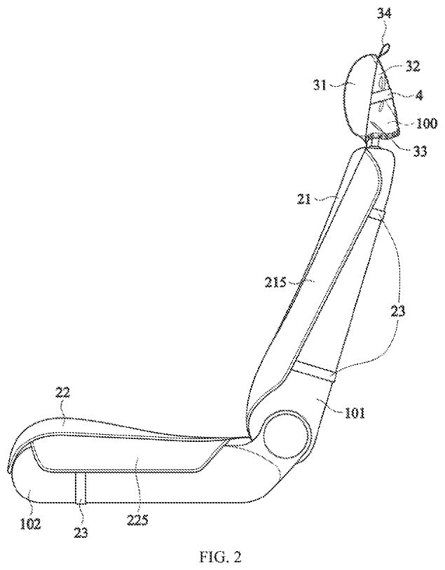

Please refer to FIG. 1 and FIG. 2 together. In an embodiment of the present invention, a seat cover for an automobile 1 of the present invention comprises a main body 2, a pocket 3 and a first fixing element 4. The main body 2 comprises a first pad 21 and a second pad 22, wherein the first pad 21 has a first edge 211 and a second edge 212 corresponding to the first edge 211, and the second pad 22 has a first edge 221 and a second edge 222 corresponding to the first edge 221, wherein the second edge 212 of the first pad 21 may be connected with the first edge 221 of the second pad 22. The pocket 3 comprises a first sheet 31, a second sheet 32 and a fixing structure 33. The first sheet 31 may be connected with the first edge 211 of the first pad 21. The first sheet 31 and the second sheet 32 may be connected with each other to form an accommodation space 35 which has an opening 36. The fixing structure 33 is disposed on the second sheet 32 and near the opening 36. The first fixing element 4 may be disposed on the pocket 3 and used for connecting and fastening the pocket 3 to the automobile seat. In an embodiment, the first fixing element 4 may be connected to the second sheet 32 of the pocket 3. Preferably, both ends of the first fixing element 4 may be connected to both sides of the second sheet 32 respectively. As shown in FIG. 2, the first sheet 31, the second sheet 32 and the fixing structure 33 may be used to cover the headrest 100 of the automobile seat so that the seat cover for an automobile 1 is partially fixed on the automobile seat. It is easy for users to overlay the first pad 21 and the second pad 22 of the main body 2 on the backrest 101 and the seat cushion 102 of the automobile seat correctly.

In an embodiment, the first pad 21 may have a third edge 213 and a fourth edge 214, wherein the third edge 213 is between the first edge 211 and the second edge 212, and the fourth edge 214 corresponds to the third edge 213. In an embodiment, the first pad 21 may comprise at least one third sheet 215, wherein the at least one third sheet 215 may be disposed along the third edge 213 or the fourth edge 214.

According to a preferred embodiment, the first pad 21 may have two third sheets 215, and the third sheets 215 are respectively connected to the third edge 213 and the fourth edge 214 of the first pad 21.

Please refer to FIG. 1 and FIG. 2 together. FIG. 2 illustrates a schematic view of a first state of use of a seat cover for an automobile according to the present invention. According to a specific embodiment of the present invention, a connection between the first pad 21 and the third sheet 215 may be draped to fit the backrest 101 and be suitable for different curvatures or depths of automobile seats. When the backrest 101 has two protruding parts disposed on two sides of the backrest 101 to increase the cladding for passengers, the draped structure of the connection between the first pad 21 and the third sheet 215 can cover or partially cover the protruding parts of the backrest 101 more completely and conformably. In a preferred embodiment, a connection between the first pad 21 and the second pad 22 may be draped to fit a junction between the backrest 101 and the seat cushion 102 so that it does not wrinkle easily. In addition to increasing comfortability of the ride, the smooth appearance of the present invention is also aesthetic.

According to an embodiment of the present invention, the first pad 21 has two third sheets 215, and the third sheet 215 has an edge 2151. The first edge 221 of the second pad 22 may be connected to the second edge 212 of the first pad 21 and one of the edges 2151 of the two third sheets 215. Preferably, a connection of the first pad 21, the second pad 22 and the third sheet 215 may be draped so that not only the seat cover of an automobile of the present invention fits the backrest 101 but also it does not wrinkle easily for the seat cover at the junction between the backrest 101 and the seat cushion 102.

The second pad 22 may have a third edge 223 and a fourth edge 224, wherein the third edge 223 is between the first edge 221 and the second edge 222, and the fourth edge 224 corresponds to the third edge 223. In an embodiment, the second pad 22 may comprise at least one fourth sheet 225, wherein the at least one fourth sheet 225 may be disposed along the third edge 223 or the fourth edge 224 of the second pad 22.

According to a preferred embodiment of the present invention, the second pad 22 may have two fourth sheets 225, and the fourth sheets 225 are respectively connected to the third edge 223 and the fourth edge 224 of the second pad 22. In this embodiment, the fourth sheet 225 enables to fix the second pad 22 on the seat cushion 102 so that the second pad 22 is not easy to be lifted or moved when the riders are riding or getting on or off the automobile.

According to an embodiment of the present invention, the main body 2 may comprise at least one second fixing element 23, wherein two ends of the at least one second fixing element 23 are respectively connected to two sides of the main body 2.

According to an embodiment of the present invention, as shown in FIG. 2, the main body 2 may comprise a plurality of second fixing element 23, wherein one of the second fixing element 23 may be connected to both sides of the first pad 21 to fix the first pad 21 on the backrest 101, and the other one of the second fixing element 23 may be connected to both sides of the second pad 22 to fix the second pad 22 on the seat cushion 102. Preferably, the first pad 21 may further comprise another second fixing element 23 so there are two second fixing elements 23 disposed on the first pad 21 and are near the first edge 211 and the second edge 212 respectively. In a different embodiment, the number of the second fixing element 23 disposed on the first pad 21 or the second pad 22 can be adjusted according to actual requirements, but not limited to the description here.

According to an embodiment of the present invention, the second fixing element 23 may be made of elastic materials or the length of the second fixing element 23 is adjustable. The second fixing element 23 may be, for example, but not limited to an elastic band, a hook and loop fastener, a buckle, a snap hook or composed of other single or composite elements.

According to an embodiment in the present invention, the second pad 22 may comprise an anti-slip structure 24 disposed on a surface of the second pad 22, which contacts the seat cushion 102 to increase the friction force between the second pad 22 and the seat cushion 102 so the second pad 22 is not easy to be lifted or moved.

According to an embodiment of the present invention, the first fixing element 4 may be connected to the second sheet 32. Preferably, both ends of the first fixing element 4 may be respectively connected to both sides of the second sheet 32. In this embodiment, both ends of the first fixing element 4 are respectively connected to the edges of both sides of the second sheet 32 so the first fixing element 4 can be located in front of the second sheet 32 or flipped in front of the first sheet 31.

According to an embodiment of the present invention, the first fixing element 4 may be made of elastic materials or the length of the first fixing element 4 may be adjustable. In this embodiment, the first fixing element 4 may be, for example, but not limited to an elastic band, a hook and loop fastener, a buckle, a snap hook or composed of other single or composite elements.

According to an embodiment of the present invention, the main body 2 and the pocket 3 may be integrally formed. In this embodiment, there is substantially no seams for connection between the first pad 21 and the first sheet 31.

According to an embodiment of the present invention, the first pad 21, the second pad 22 and the third sheet 215 may be integrally formed. In this embodiment, there is substantially no seams for connection between the second edge 212 and the first edge 22, and between the third sheet 215 and the third edge 213, and between the third sheet 215 and the fourth edge 214.

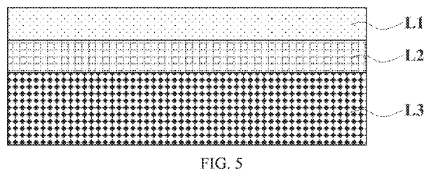

Please refer to FIG. 5. According to an embodiment of the present invention, the main body 2 or the pocket 3 may comprise two layer structures (not shown in the drawings), wherein a first layer structure L1 of the two layer structures in contact with the riders may be made of water absorbing, antimicrobial, deodorizing or mildewproof materials such as polyester fiber or nylon, but not limited thereto. A second layer structure L2 of the two layer structures may be made of waterproof materials such as thermoplastic polyurethane (TPU), but not limited thereto. According to another embodiment of the present invention, the main body 2 or the pocket 3 may comprise three layer structures, as shown in FIG. 5. In addition to the first layer structure L1 and the second layer structure L2 as mentioned above, the main body 2 or the pocket 3 may further comprise a third layer structure L3. The materials of the third layer structure L3 may be polyester fiber, but not limited to, to increase the thickness and strength of the main body 2. Preferably, a thickness of the third layer structure L3 may be more than that of the first layer structure L1 or the second layer structure L2. In this embodiment, the second layer structure L2 is the one made of waterproof materials and disposed between the first layer structure L1 and the third layer structure L3. Due to its materials, the seat cover for automobile of the present invention do not cause muggy and uncomfortable riding experience that is the problems of the prior art.

According to an embodiment of the present invention, the seat cover for an automobile 1 of the present invention is washable. It can be easily and quickly removed from the automobile seat and washed in washing machine due to its materials and structures. The present invention is easy to clean without affecting its normal function.

In an embodiment, the pocket 3 is draped to fit the headrest 100 more conformably.

According to an embodiment of the present invention, the pocket 3 may comprise a pull strap 34 which may be disposed on a side of the pocket 3 away from the first pad 21 and substantially disposed at the connection between the first sheet 31 and the second sheet 32. When removing the seat cover for an automobile 1, users can pull up the pull strap 34 to separate the pocket 3 from the headrest 100.

According to an embodiment of the present invention, the first sheet 31 or the second sheet 32 may be made of elastic materials. In this embodiment, the accommodation space 35 of the pocket 3 may be accordingly expanded or reduced.

In a specific embodiment, both sides of the first sheet 31 are made of elastic materials, and the second sheet 32 is entirely made of elastic materials.

According to an embodiment of the present invention, as shown in FIG. 2, the accommodation space 35 of the pocket 3 is used to accommodate the headrest 100, wherein the second sheet 32 may be made of elastic materials, so the pocket 3 enables to cover the headrest 100 easily and is suitable for all types of automobile headrests.

According to another embodiment of the present invention, when the automobile seat is not necessary to be covered by the seat cover for an automobile, the main body 2 can be stored in the accommodation space 35 of the pocket 3. In this embodiment, a maximum length of the accommodation space 35 of the pocket 3 is substantially not less than a length of the first edge 211 of the first pad 21, and the second sheet 32 is made of elastic materials so that the main body 2 can be folded or rolled to be stored in the pocket 3 smoothly

According to an embodiment of the present invention, when the main body 2 is stored in the accommodation space 35 of the pocket 3, the fixing structure 33 disposed on the second sheet 32 near the opening 36 is used to secure the opening 36 and prevents the main body 2 from leaving out the accommodation space 35. In this embodiment, the fixing structure 33 can be, for example, an elastic band, a drawstring, a strap closure, a hook and loop fastener, a zipper or composed of other single or composite elements, but not limited thereto.

In an embodiment, the main body 2 has a shape of cuboid or cylinder after being folded or rolled.

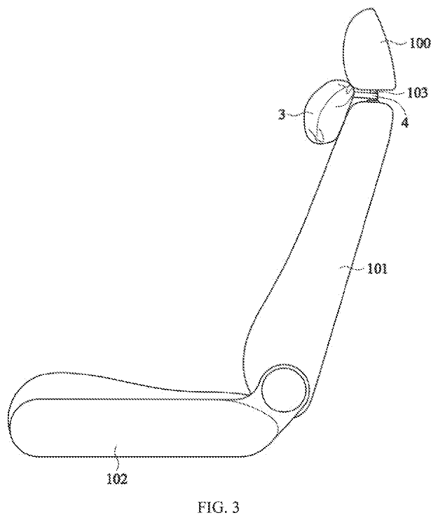

Please refer to FIG. 3. FIG. 3 illustrates a schematic view of a second state of use of a seat cover for an automobile according to the present invention. When the main body 2 is stored in the accommodation space 35 of the pocket 3, a space between the first fixing element 4 and the pocket 3 may be used to accommodate the headrest 100 or support rods 103 connecting the backrest 101 and the headrest 100 so that the pocket 3 is kept in front of the headrest 100 to form or be used as a neck pillow.

According to a preferred embodiment of the present invention, the first fixing element 4 is substantially parallel to the first edge 211 of the first pad 21. When the main body 2 has a shape of cylinder and is used as a neck pillow, the cylindrical main body 2 may be fixed by the first fixing element 4 in transverse orientation that is beneficial for the rider's neck to lean on.

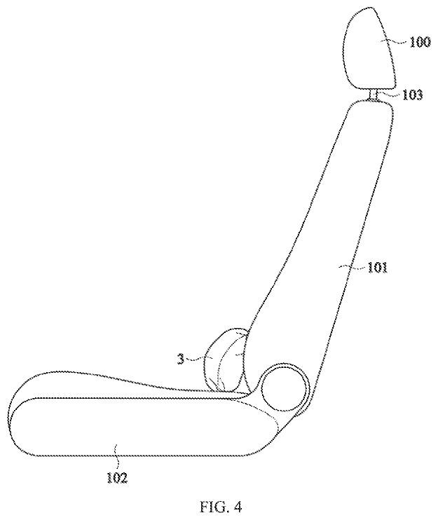

Please refer to FIG. 4. FIG. 4 illustrates a schematic view of a third state of use of a seat cover for an automobile according to the present invention. When the main body 2 is stored in the accommodation space 35 of the pocket 3, the pocket 3 may be placed on the seat cushion 102 near the backrest 101 of the automobile seat to form or be used as a lumbar pillow.

According to an embodiment of the present invention, when the main body 2 is stored in the accommodation space 35 of the pocket 3, the seat cover of an automobile 1 can be hung for storage by the pull strap 34.

Compared to the prior art, the components of the main body, the components of the pocket or the first fixing element of the present invention can be made of water absorbing, antimicrobial, deodorizing, mildewproof, waterproof, anti-slip or wear-resistant materials. The functional fabric composed of these materials is waterproof and has, for example, water absorbing, antimicrobial and deodorizing functions to ensure that liquids, such as sweat or beverages, would be absorbed and not permeate to the bottom of the seat cover for an automobile, and the smudges left on the seat cover for an automobile would not leave stink odor as time goes by. In addition, the components and structures of the seat cover for an automobile according to the present invention enable the main body to be stored in the accommodation space 35 of the pocket. In one aspect, it is convenient for storage and easy to carry. In another aspect, the main body of the seat cover for an automobile can be folded for storage in different forms according to different shapes of the users and the automobile seats to form or be used as a buffering pad having different thicknesses. For example, the cylindrical main body may be used for the space between the neck and the automobile seat as a neck pillow supporting the rider's neck, or the cuboid main body may be used for the space between the back and the automobile seat as a lumbar pillow supporting the rider's lumbar. The present invention not only enhances the comfortability of the ride but also increases the usability and worth of the seat cover for an automobile, and solves the aforementioned problems in the prior art.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A seat cover for an automobile in which an automobile seat has a seat cushion, a backrest and a headrest, wherein the seat cover for an automobile comprises:
a main body comprising a first pad and a second pad, wherein the first pad has a first edge and a second edge corresponding to the first edge of the first pad, and the second pad has a first edge and a second edge corresponding to the first edge of the second pad, wherein the second edge of the first pad is connected with the first edge of the second pad;
a pocket comprising:
a first sheet connected with the first edge of the first pad;
a second sheet substantially connected with the first sheet to form an accommodation space which has an opening; and
a fixing structure disposed on the second sheet and substantially near the opening; and
a first fixing element disposed on the pocket and used for connecting and fastening the pocket to the automobile seat.

2. The seat cover for an automobile of claim 1, wherein the accommodation space is used to accommodate the headrest of the automobile seat or the main body.

3. The seat cover for an automobile of claim 2, wherein the main body has a shape of cuboid or cylinder.

4. The seat cover for an automobile of claim 2, wherein both ends of the first fixing element are respectively connected to both sides of the second sheet of the pocket, and a space between the first fixing element and the pocket is used to accommodate the headrest or support rods connecting the backrest and the headrest of the automobile seat.

5. The seat cover for an automobile of claim 2, wherein the pocket is placed on the seat cushion and near the backrest of the automobile seat.

6. The seat cover for an automobile of claim 1, wherein the pocket further comprises a pull strap disposed on a side of the pocket away from the first pad.

7. The seat cover for an automobile of claim 1, wherein the main body further comprises at least one second fixing element, wherein both ends of the at least one second fixing element are respectively connected to both sides of the main body.

8. The seat cover for an automobile of claim 1, wherein the first pad further has a third edge and a fourth edge, wherein the third edge is between the first edge and the second edge of the first pad and the fourth edge corresponds to the third edge of the first pad, and the first pad further comprises at least one third sheet, wherein the at least one third sheet is disposed along the third edge or the fourth edge of the first pad.

9. The seat cover for an automobile of claim 8, wherein the first edge of the second pad is connected to the second edge of the first pad and a edge of the at least one third sheet.

10. The seat cover for an automobile of claim 1, wherein the second pad further has a third edge and a fourth edge, wherein the third edge is between the first edge and the second edge of the second pad and the fourth edge corresponds to the third edge of the second pad, and the second pad further comprises at least one fourth sheet, wherein the at least one fourth sheet is disposed along the third edge or the fourth edge of the second pad.

11. The seat cover for an automobile of claim 1, wherein a maximum length of the accommodation space is not less than a length of the first edge of the first pad.

12. The seat cover for an automobile of claim 1, wherein part or all of the first sheet, the second sheet or the first fixing element is made of elastic materials.

13. The seat cover for an automobile of claim 1, wherein the second pad further comprises an anti-slip structure disposed on a surface of the second pad, which contacts the automobile seat.

14. The seat cover for an automobile of claim 1, wherein the main body and the pocket are integrally formed or formed by draping technique.

15. The seat cover for an automobile of claim 1, wherein the main body or the pocket comprises a first layer structure and a second layer structure, wherein the first layer structure is made of water absorbing, antimicrobial, deodorizing or mildewproof materials and the second layer structure is made of waterproof materials.
